(19) United States
(12) Patent Application Publication
(10) Pub. No.: US 2012/0323441 A1
(43) Pub. Date: Dec. 20, 2012

(54) VEHICLE LIGHT CONTROL DEVICE

(75) Inventor: Chien-Chih Yu, Kaohsiung City (TW)

(73) Assignee: KWANG YANG MOTOR CO., LTD., Kaohsiung (TW)

(21) Appl. No.: 13/524,276

(22) Filed: Jun. 15, 2012

(30) Foreign Application Priority Data
Jun. 17, 2011 (TW) 100121180

(51) Int. Cl. B60Q 1/08

(52) U.S. Cl. 701/36

(57) ABSTRACT

A vehicle light control device includes: a power unit capable of supplying electric power to a vehicle light unit; a wheel speed detecting circuit detecting a wheel speed of a vehicle so as to generate a wheel speed signal indicating the wheel speed of the vehicle; and a control unit determining, based on the wheel speed signal, whether the wheel speed of the vehicle is lower than a predetermined wheel speed threshold when a rotational speed of an engine of the vehicle reaches a predetermined rotational speed threshold, and operable to enable the power unit to output a low duty-cycle voltage serving as electric power to a vehicle light unit upon determining that the wheel speed of the vehicle is lower than the predetermined wheel speed threshold.

### CROSS-REFERENCE TO RELATED APPLICATION

This application claims priority to Taiwanese Application No. 100121180, filed on Jun. 17, 2011, the contents of which are hereby incorporated by reference.

### BACKGROUND OF THE INVENTION

1. Field of the Invention

The invention relates to a vehicle light control device, and more particularly to a vehicle light control device capable of adjusting electric power supplied to a vehicle light based on a vehicle wheel speed.

2. Description of the Related Art

Currently, a motorcycle is designed to have a pair of symmetric headlights (i.e., dual headlights) to increase a lighting range so as to improve safety for a rider. Due to the increment of the headlights, the amount of an electric current supplied from a motorcycle battery thus increases. Thus, to prolong the service lift of a battery of such motorcycle and to ensure an amount of an electric current supplied from the battery sufficient to activation of the headlights, a small generator mounted on such motorcycle is used to generate a charging current to charge the battery.

In addition, to ensure driving safety in a dark environment, a charge-back control mechanism is designed in a motorcycle to charge a battery of the motorcycle under specific conditions so as to obtain a sufficient electric current supplied to headlights so that the headlights can provide security lighting. Through such charge-back control mechanism, effective and accurate charging of the battery can be achieved under the premise of security lighting, thereby avoiding waste of electricity generated by the generator or stored in the battery during low or idle speed of the motorcycle.

Generally, when designing a motorcycle, various factors, such as the overall performance, electricity consumption, etc., are taken into account, and a proper battery and lights, for example headlights, with standard specification, for example 12V, 35W, are selected such that security lighting and long service life of the battery can be attained. However, in a conventional operating mode, a voltage with a duty cycle of 100% is supplied to headlights of a motorcycle once the motorcycle is started while the headlights are activated. Nevertheless, since it impossible for a rider to carefully watch and identify surrounding scenes at a lighting output with a relatively low power when the motorcycle is operated in a low-speed or idle-speed state, the headlights controlled by such operating mode may result in higher power consumption.

Therefore, improvements may be made to the above techniques.

### SUMMARY OF THE INVENTION

Therefore, an object of the present invention is to provide that can adjust electric power supplied to a vehicle light based on a vehicle wheel speed and that can overcome the aforesaid drawbacks of the prior art.

According to the present invention, a vehicle light control device includes a power unit, a wheel speed detecting circuit, and a control unit.

The power unit is adapted to be electrically connected to a light unit mounted on a vehicle and is capable of supplying electric power to the light unit.

The wheel speed detecting circuit is adapted for detecting a wheel speed of the vehicle so as to generate a wheel speed signal indicating the wheel speed of the vehicle.

The control unit is connected electrically to the power unit and the wheel speed detecting circuit, and receives the wheel speed signal from the wheel speed detecting circuit and an external engine rotational speed signal indicating a rotational speed of an engine of the vehicle. The control unit is operable to determine, based on the wheel speed signal received thereby, whether the wheel speed of the vehicle is lower than a predetermined wheel speed threshold upon detecting that the rotational speed of the engine of the vehicle reaches a predetermined rotational speed threshold, and to enable the power unit to output a low duty-cycle voltage serving as the electric power to the light unit upon determining that the wheel speed of the vehicle is lower than the predetermined wheel speed threshold.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating the preferred embodiment of a vehicle light control device according to the present invention; and

FIG. 2 is a flow chart of a vehicle light control method performed by the preferred embodiment.

### DETAILED DESCRIPTION OF THE PREFERRED EMBODIMENT

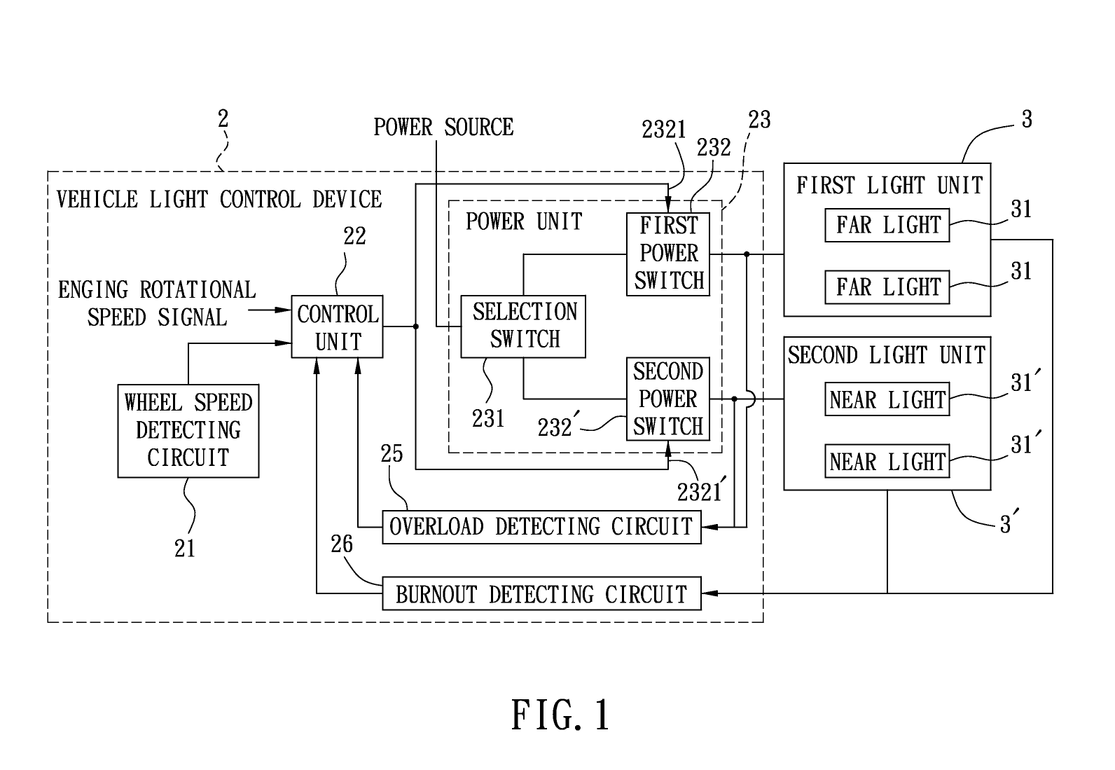

Referring to FIG. 1, the preferred embodiment of a vehicle light control device 2 according to the present invention is shown to include a power unit 23, a wheel speed detecting circuit 21, a control unit 22, an overload detecting circuit 25, and a burnout detecting circuit 26. The vehicle light control device 2 is used to control a vehicle light device mounted on a vehicle (not shown), such as a motorcycle. In this embodiment, the vehicle light device includes a first light unit 3 consisting of dual far lights 31 connected in parallel, and a second light unit 3′ consisting of dual near lights 31′ connected in parallel.

The power unit 23 is adapted to be connected electrically to the vehicle light device, and is capable of supplying electric power to the vehicle light device. In this embodiment, the power unit 23 includes a first power switch 232 adapted to be connected electrically to the first light unit 3, a second power switch 232′ adapted to be connected electrically to the second light unit 3′, and a selection switch 231 connected electrically among an external power source, and the first and second power switches 232, 232′. The selection switch 231 is manually operable to establish connection between the power source and a selected one of the first and second power switches 232, 232′ such that electric power from the power source can be transmitted to the selected one of the first and second power switches 232, 232′ through the selection switch 231. Each of the first and second power switches 232, 232′ is a MOSFET, and has a control end 2321, 2321′ for receiving a control signal such that each of the first and second power switches 232, 232′ is operable between an ON-state and an OFF-state in response to the control signal received at the control end 2321, 2321′ thereof. In this case, when the selected one of the first and second power switches 232, 232′ is in the ON-state, the electric power transmitted thereto is output to a desired one of the first and second light units 3, 3′ connected electrically to the selected one of the first and second power switches 232, 232′. In other words, a vehicle's user can select the first light unit 3, i.e., the far lights 31, or the second light unit 3′, i.e., the near lights 31′, to be lighted as required through manual operation of the selection switch 231.

The wheel speed detecting circuit 21 is adapted for detecting a wheel speed of the vehicle using a known manner so as to generate a wheel speed signal indicating the wheel speed of the vehicle that can be shown in a dashboard of the vehicle.

The control unit 22 is connected electrically to the wheel speed detecting circuit 21 and the control ends 2321, 2321′ of the first and second power switches 232, 232′, and receives the wheel speed signal from the wheel speed detecting circuit 21 and an external engine rotation speed signal indicating a rotational speed of an engine (not shown) of the vehicle. Initially, the control unit 22 is operable to determine, based on the external engine rotational speed signal received thereby, whether the rotational speed of the engine reaches a predetermined rotational speed threshold. In this embodiment, the predetermined rotational speed threshold is 200 rpm. Upon determining that the rotational speed of the engine reaches the predetermined rotational speed threshold, the control unit 22 is operable to determine, based on the wheel speed signal received thereby, whether the wheel speed of the vehicle is lower than a predetermined wheel speed threshold. In this embodiment, the wheel speed threshold is 4 km/hr. Upon determining that the wheel speed of the vehicle is lower than the predetermined wheel speed threshold, the control unit 22 is operable to enable the power unit 23 to output a low duty-cycle voltage serving as the electric power to the desired one of the first and second light units 3, 3′. In this embodiment, the low duty-cycle voltage has a duty cycle of 30%±3%. In this case, the control unit 22 generates the control signal such that the selected one of the first and second power switches 232, 232′ operates based on the control signal so as to reduce the ON-state period thereof, thereby enabling the selected one of the first and second power switches 232, 232′ to output the low duty-cycle voltage. On the other hand, upon determining that the wheel speed of the vehicle is not lower than the predetermined wheel speed threshold, i.e., 4 km/hr, the control unit 22 is operable to enable the power unit 23 to output a high duty-cycle voltage serving as the electric power to the desired one of the first and second light units 3, 3′. In this embodiment, the high duty-cycle voltage has a duty cycle of 100%. In this case, the control unit 22 generates the control signal such that the selected one of the first and second power switches 232, 232′ is remained in the ON-state based on the control signal. It is noted that, when the wheel speed of the vehicle is not lower than the predetermined wheel speed threshold, the power unit 23 is controlled by the control unit 22 to output the high duty-cycle voltage even though the rotational speed of the engine of the vehicle becomes zero.

In addition, when the control unit 22 determines that the wheel speed of the vehicle is lower than the predetermined wheel speed threshold and that the rotational speed of the engine of the vehicle becomes zero, the control unit 22 is operable to enable the power unit 23 to cease outputting the electric power. In this case, the control unit 22 generates the control signal such that the selected one of the first and second power switches 232, 232′ is operated in the OFF-state based on the control signal, thereby ceasing outputting the electric power.

The overload detecting circuit 25 is connected electrically to the control unit 22 for detecting an electric current flowing into the desired one of the first and second light units 3, 3′. The overload detecting circuit 25 is operable to output an overload signal to the control unit 22 upon determining that the electric current flowing into the desired one of the first and second light units 3, 3′ is greater than a predetermined electric current threshold. Thus, the control unit 22 generates the control signal in response to the overload signal from the overload detecting circuit 25 such that the selected one of the power switches 232, 232′ is operated in the OFF-state based on the control signal, thereby ceasing outputting the electric power to the desired one of the first and second light units 3, 3′.

The burnout detecting circuit 26 is connected electrically to the control unit 22 for detecting whether one of the far/near lights 31, 31′ of the desired one of the first and second light units 3, 3′ is burnt out. The burnout detecting circuit 26 is operable to output a burnout signal to the control unit 22 upon determining that one of the far/near lights 31, 31′ of the desired one of the first and second light units 3, 3′ is burnt out. Thus, the control unit 22 generates the control signal in response to the burnout signal from the burnout detecting circuit 26 such that the selected one of the power switches 232, 232′ is operated in the OFF-state based on the control signal, thereby ceasing outputting the electric power to the first and second light units 3, 3′.

It is noted that the control unit 22 can be implemented into an electronic control unit (ECU) or a microcomputer chip of a vehicle dashboard module.

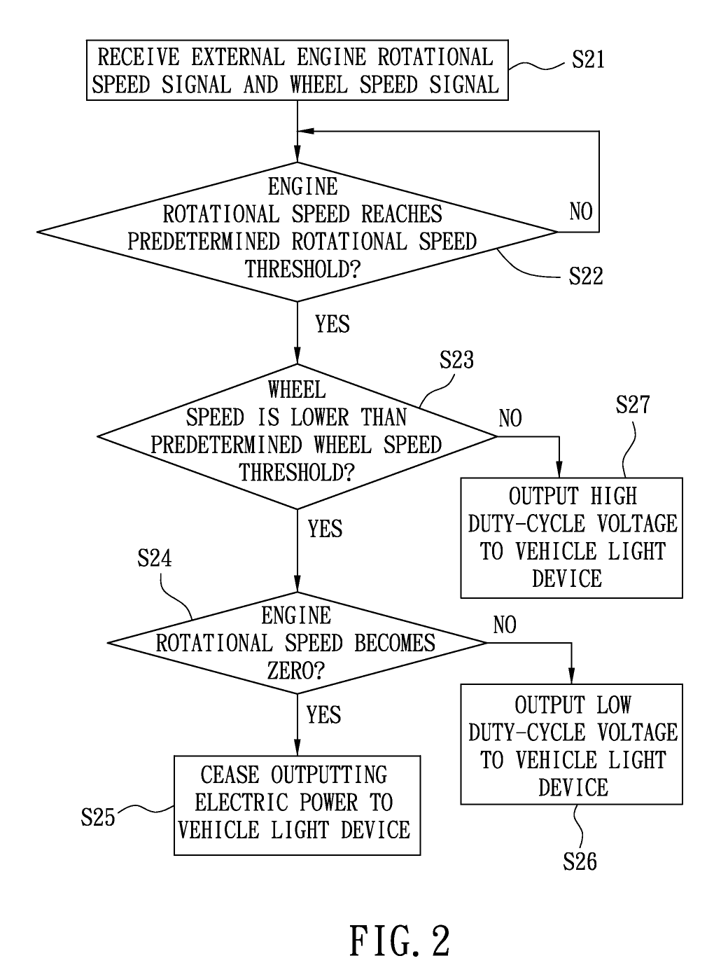

FIG. 2 illustrates a flow chart of a vehicle light control method performed by the vehicle light control device 2 of the preferred embodiment.

In step S21, the control unit 22 receives the external engine rotational speed signal and the wheel speed signal from the wheel speed detecting circuit 21.

In step S22, the control unit 22 is configured to determine, based on the external engine rotational speed signal, whether the rotational speed of the engine of the vehicle reaches the predetermined rotational speed threshold. If the result is affirmative, the flow proceeds to step S23. Otherwise, the flow goes back to step S22.

In step S23, the control unit 22 is configured to determine, based on the wheel speed signal from the wheel speed detecting circuit 21, whether the wheel speed of the vehicle is lower than the predetermined wheel speed threshold. If the result is affirmative, the flow proceeds to step S24. Otherwise, the flow goes to step S27.

In step S24, the control unit 22 is configured to determine, based on the external engine rotational speed signal, whether the rotational speed of the engine of the vehicle becomes zero. If the result is affirmative, the flow proceeds to step S25. Otherwise, the flow goes to step S26.

In step S25, when the wheel speed of the vehicle is lower than the predetermined wheel speed threshold while the rotational speed of the engine of the vehicle becomes zero, the control unit 22 is configured to enable the power unit 23 to cease outputting the electric power to the vehicle light device.

In step S26, when the wheel speed of the vehicle is lower than the predetermined wheel speed threshold while the rotational speed of the engine of the vehicle is not equal to zero, the control unit 22 is configured to enable the power unit 23 to output the low duty-cycle voltage serving as the electric power to the vehicle light device.

In step S27, when the wheel speed of the vehicle is not lower than the predetermined wheel speed threshold, the control unit 22 is configured to enable the power unit 23 to output the high duty-cycle voltage serving as the electric power to the vehicle light device.

In sum, since the control unit 22 enables the power unit 23 to output the low duty-cycle voltage serving as the electric power to the vehicle light device when the wheel speed of the vehicle is lower than the predetermined wheel speed threshold, the vehicle light control device of the present invention can reduce power consumption of the vehicle light device as compared to the prior art. Furthermore, due to the presence of the overload detecting circuit 25 and the burnout detecting circuit 26, the vehicle light control device of the present invention can also meet relevant safety requirements for motorcycles required by Economic Commission for Europe (ECE).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A vehicle light control device comprising:
a power unit adapted to be electrically connected to a light unit mounted on a vehicle and capable of supplying electric power to the light unit;
a wheel speed detecting circuit adapted for detecting a wheel speed of the vehicle so as to generate a wheel speed signal indicating the wheel speed of the vehicle; and
a control unit connected electrically to said power unit and said wheel speed detecting circuit, and receiving the wheel speed signal from said wheel speed detecting circuit and an external engine rotational speed signal indicating a rotational speed of an engine of the vehicle, said control unit being operable to determine, based on the wheel speed signal received thereby, whether the wheel speed of the vehicle is lower than a predetermined wheel speed threshold when the rotational speed of the engine of the vehicle reaches a predetermined rotational speed threshold, and to enable said power unit to output a low duty-cycle voltage serving as the electric power to the light unit upon determining that the wheel speed of the vehicle is lower than the predetermined wheel speed threshold.

2. The vehicle light control device as claimed in claim 1, wherein the low duty-cycle voltage has a duty cycle of 30%±3%.

3. The vehicle light control device as claimed in claim 1, wherein said control unit is operable to enable said power unit to output a high duty-cycle voltage serving as the electric power to the light unit upon determining that the wheel speed of the vehicle is not lower than the predetermined wheel speed threshold.

4. The vehicle light control device as claimed in claim 3, wherein the high duty-cycle voltage has a duty cycle of 100%.

5. The vehicle light control device as claimed in claim 1, wherein said control unit is operable to enable said power unit to cease outputting the electric power to the light unit upon determining that the wheel speed of the vehicle is lower than the predetermined wheel speed threshold while the rotational speed of the engine of the vehicle becomes zero.

6. The vehicle light control device as claimed in claim 1, wherein the predetermined wheel speed threshold is 4 km/hr.

7. The vehicle light control device as claimed in claim 1, wherein the predetermined rotational speed threshold is 200 rpm.
